(19) United States
(12) Patent Application Publication
(10) Pub. No.: US 2010/0328431 A1
(43) Pub. Date: Dec. 30, 2010

(54) Rendering method and apparatus using sensor in portable terminal

(75) Inventors: Jung-Nyun Kim, Suwon-si (KR); Sang-Bong Lee, Suwon-si (KR); Dae-Kyu Shin, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/803,594

(22) Filed: Jun. 30, 2010

(30) Foreign Application Priority Data
Jun. 30, 2009 (KR) 10-2009-0058920

(51) Int. Cl. H04N 5/228; H04N 13/02

(52) U.S. Cl. 348/46; 348/208.4; 348/E05.031; 348/E13.074

(57) ABSTRACT

A method and an apparatus detect motion, rotation, and tilt for rendering using a sensor in a portable terminal. The rendering method using the sensor in the portable terminal includes pre-rendering a region of a size corresponding to a screen of the terminal and a surrounding region. A preset region of the pre-rendered regions is displayed. A motion of the terminal is detected using a sensor, and a region to display in the pre-rendered regions is changed according to the motion.

### CROSS-REFERENCE TO RELATED APPLICATION(S) AND CLAIM OF PRIORITY

The present application is related to and claims the benefit of priority under 35 U.S.C. §119(a) to a Korean patent application filed in the Korean Intellectual Property Office on Jun. 30, 2009 and assigned Serial No. 10-2009-0058920, the entire disclosure of which is hereby incorporated by reference.

### TECHNICAL FIELD OF THE INVENTION

The present invention relates generally to a method and an apparatus for rendering using a sensor in a portable terminal. More particularly, the present invention relates to a method and an apparatus for steady rendering by detecting motion, rotation, and tilt of a terminal using a sensor. Herein, steady rendering refers to rendering a 3D screen without jitter or size change even when the terminal rotates or shakes.

### BACKGROUND OF THE INVENTION

Recently, as automation proceeds and advances toward the information society progresses, applications of computer graphics are rapidly increasing. In particular, fields using 3D graphics are rapidly growing. For example, conventional portable terminals service 3D graphic games or 3D graphic maps.

Meanwhile, portable terminals including a geomagnetic sensor, an acceleration sensor, and a gyro sensor provide a function for switching the screen by detecting the tilt of the terminal. FIG. 1 illustrates display modes switched based on rotation in a conventional portable terminal. For example, when detecting the rotation to a portrait mode using the sensor while displaying an image in a landscape mode, the portable terminal provides a function to properly resize the displayed image in the portrait mode as shown in FIG. 1.

However, when the display image is resized by switching from the landscape mode to the portrait mode based on the rotation of the portable terminal, blank regions occur in the screen of the portable terminal and thus the utilization of the whole screen degrades. Moreover, when the display image is a 3D image, processing for the resizing is quite considerable. Consequently, as the resizing of the screen is not carried out as soon as the terminal is rotated, this can frustrate a user. When the portable terminal includes a touch screen—that is, when the screen is equipped with touch buttons or other function buttons—as the portable terminal is rotated and the positions of the buttons are changed frequently, the user can feel inconvenience in the awkward key manipulation. In addition, since the conventional portable terminals do not provide a technique for correcting the screen based on the motion of the user, the user who is walking or riding on the bus has a difficulty in watching the screen of the portable terminal because of the shaking.

### SUMMARY OF THE INVENTION

To address the above-discussed deficiencies of the prior art, it is a primary aspect of the present invention to provide a method and an apparatus for steady rendering using a sensor in a portable terminal.

Another aspect of the present invention is to provide a method and an apparatus for pre-rendering a region displayed in a screen and surrounding regions in portable terminal.

Yet another aspect of the present invention is to provide a rendering method and a rendering apparatus for providing a screen at the same time as the rotation in a portable terminal.

Still another aspect of the present invention is to provide a rendering method and a rendering apparatus for changing a region displayed in a screen according to shaking of a portable terminal in the portable terminal.

Yet another aspect of the present invention is to provide a rendering method and a rendering apparatus for adjusting a camera view according to tilt of a portable terminal in the portable terminal.

According to one aspect of the present invention, a rendering method using a sensor in a portable terminal includes pre-rendering a region of a size corresponding to a screen of the terminal and a surrounding region. A preset region of the pre-rendered regions is displayed. A motion of the terminal is detected using a sensor, and a region to display in the pre-rendered regions is changed according to the motion.

According to another aspect of the present invention, a rendering apparatus using a sensor in a portable terminal includes a sensor for detecting motion of the terminal. A rendering module pre-renders a region of a size corresponding to a screen of the terminal and a surrounding region and changes a region to display in the pre-rendered regions according to the motion. And a display module displays a region determined by the rendering module among the pre-rendered regions.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates display modes switched based on rotation in a conventional portable terminal;

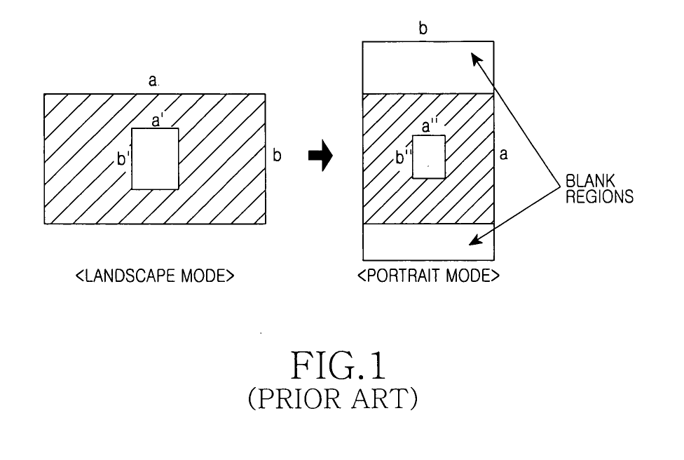

FIG. 2 illustrates a portable terminal according to an embodiment of the present invention;

FIGS. 3A to 3C illustrate a rendering region and a display region based on rotation in the portable terminal according to an embodiment of the present invention;

FIGS. 4A and 4B illustrate screens displayed in the portable terminal which is rotated according to an embodiment of the present invention;

FIGS. 5A and 5B illustrate the display region based on the shaking in the portable terminal according to an embodiment of the present invention;

FIGS. 6A to 6C illustrate a camera view changed according to the tilt in the portable terminal according to an embodiment of the present invention; and

FIG. 7 illustrates a display process based on the rendering and the motion of the portable terminal according to an embodiment of the present invention.

Throughout the drawings, like reference numerals will be understood to refer to like parts, components and structures.

### DETAILED DESCRIPTION OF THE INVENTION

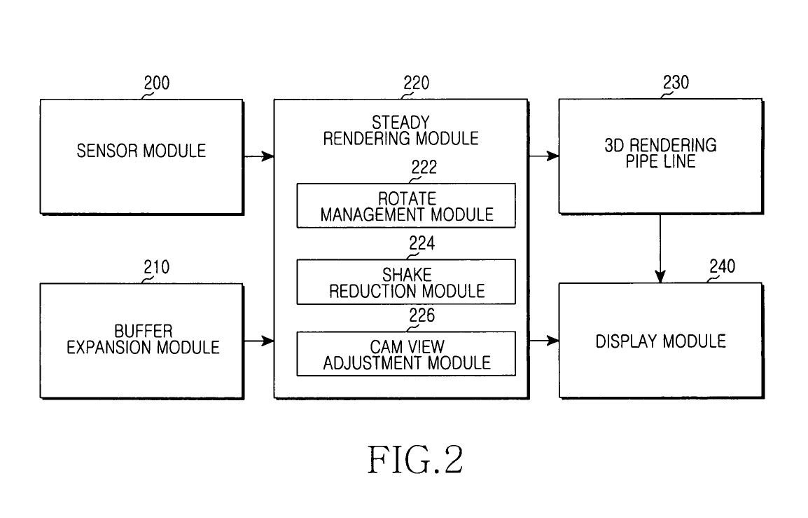

FIGS. 2 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminals.

Embodiments of the present invention provide a technique for pre-rendering surrounding regions besides a region displayed in a screen, detecting motion of the portable terminal using a sensor, and changing the region displayed in the screen based on the detected motion in the portable terminal. Herein, the rendering produces a 3D image by giving reality to a 2D image based on external information such as light source, location, and colors.

FIG. 2 is a block diagram of a portable terminal according to an embodiment of the present invention.

Referring to FIG. 2, the portable terminal includes a sensor module 200, a buffer expansion module 210, a steady rendering module 220, a 3D rendering pipe line 230, and a display module 240. The steady rendering module 220 includes a rotate management module 222, a shake reduction module 224, and a cam view adjustment module 226.

The sensor module 200 measures a direction, acceleration, and a slope of motion of the terminal, and converts the measured values to digital values. The sensor module 200 may be implemented using a gyro sensor, a geomagnetic sensor, or an acceleration sensor.

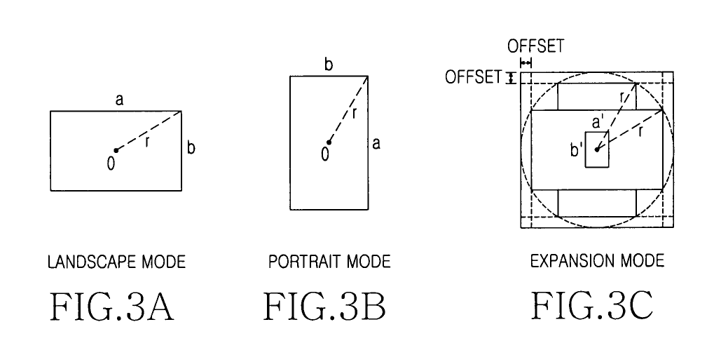

The buffer expansion module 210 determines a region for rendering 3D graphic data by expanding a size of a frame buffer. The buffer expansion module 210 expands the size of the frame buffer by considering size information of the screen and a performance of the sensor module 200, and provides the size of the expanded frame buffer to the steady rendering module 220. Herein, the buffer expansion module 210 extends the size of the frame buffer in order to pre-render a region displayed in the screen of the portable terminal and its surrounding regions. That is, since the size of the frame buffer corresponds to the screen of the portable terminal, the size of the frame buffer is expanded to render the region greater than the screen of the portable terminal. Herein, the frame buffer may be expanded up to the size of the square which circumscribes the circle in which the distance r from the center O of the screen of the portable terminal to the vertex as its radius as shown in FIG. 3C. In other words, the frame buffer may be expanded to cover both of the landscape mode screen and the portrait mode screen of FIGS. 3A and 3B. Herein, the offset indicating the difference between the rendering region and the screen region in FIG. 3C may be newly updated every time the screen is zoomed in or out.

The steady rendering module 220 determines image data to display, and controls and processes functions for rendering and displaying the image data as a 3D graphic image. The steady rendering module 220 determines the image data to be rendered to the 3D graphic image in accordance with the region corresponding to the size of the frame buffer as determined by the buffer expansion module 210. In particular, the steady rendering module 220 including the rotate management module 222, the shake reduction module 224, and the cam view adjustment module 226 changes the region to display through the display module 240 in the regions rendered by the 3D rendering pipe line 230 according to the motion of the terminal. In detail, the steady rendering module 220 controls the 3D rendering pipe line 230 to pre-render the surrounding regions besides the region displayed in the screen. When the motion of the terminal is detected, the steady rendering module 220 functions to merely update the region to display in the screen among the pre-rendered image regions, rather than resizing or rotating the rendered image.

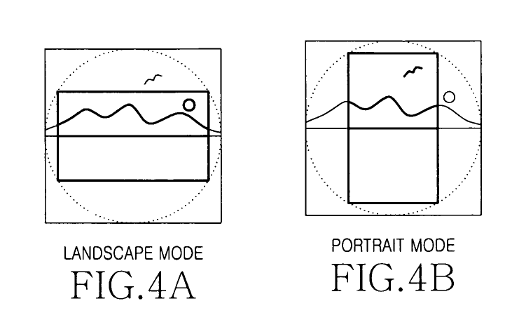

The rotate management module 222 obtains information indicating the rotation of the portable terminal using the sensor module 200, and changes the region to display through the display module 240 among the regions rendered by the 3D rendering pipe line 230 according to the rotation. For example, when the terminal displaying in the landscape mode pre-renders the region to display and its surrounding regions in the landscape screen as shown in FIG. 4A, and the terminal is rotated by 90 degrees, the terminal switches to the portrait screen by rotating the display region by 90 degrees in the pre-rendered region as shown in FIG. 4B.

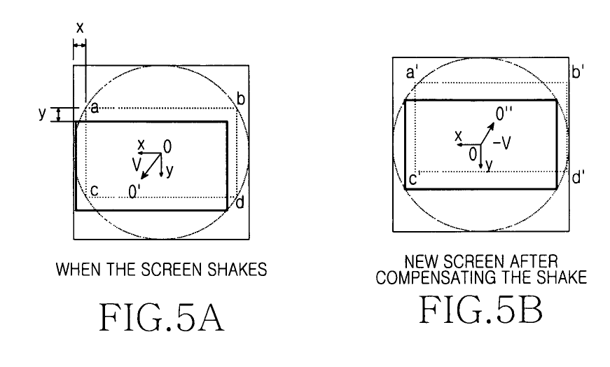

The shake reduction module 224 obtains information indicating the shaking level of the portable terminal using the sensor module 200, and changes the region to display through the display module 240 among the regions rendered by the 3D rendering pipe line 230 according to the shaking level. More specifically, the shake reduction module 224 determines the distance according to the shaking of the terminal using the direction and acceleration information of the terminal acquired from the sensor module 200, and then determines a motion vector. To get rid of the shake of the screen according to the shake of the terminal, the shake reduction module 224 should determine the display region such that the center of the screen is shifted in the opposite direction from the direction of the terminal. When the center O of the screen is shifted to O′ because of the shaking and the motion vector V generated as shown in FIG. 5A, the shake reduction module 224 changes the display region (abcd→a′b′c′d′) by readjusting the center of the screen from O to O″ as much as the inverse vector magnitude of the vector −V as shown in FIG. 5B. In so doing, when the shake exceeds an offset range as shown in FIG. 3C, the screen of the terminal also shakes. Thus, the shake reduction module 224 may change the display region only when the shake level input through the sensor module 200 is less than or equal to a preset threshold, and may not change the display region when the shake level is greater than the preset threshold. When the shake changes the center of the rendering region and the center of the screen, the shake reduction module 224 processes to newly render the region corresponding to the size of the expanded buffer based on the center of the changed screen.

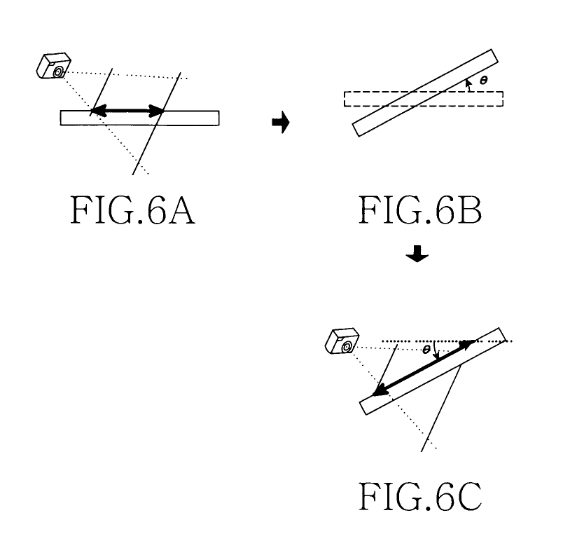

The cam view adjustment module 226 obtains information indicating the tilt of the portable terminal using the sensor module 200, and adjusts the viewpoint of the camera view which defines the viewpoint for displaying the 3D graphic image based on the tilt. For example, when the terminal is tilted by θ as shown in FIGS. 6A to 6C, the viewpoint of the camera facing the 3D graphic image is processed to tilt by θ as well. That is, the cam view adjustment module 226 processes to alter the angle of the 3D graphic image displayed in the display module 240 according to the tilt of the terminal.

The 3D rendering pipe line 230 processes the function for rendering the 3D image using the information provided from the steady rendering module 220. In detail, the 3D rendering pipe line 230 conducts necessary processes until data of the vertices constituting the 3D object is converted to pixels in the ultimate screen. For example, the 3D rendering pipe line 230 fulfills a modeling transformation process which transforms a coordinate space, an optimization process which removes invisible objects in the screen, a lighting process which realizes colors according to attributes of the object and the light source, a scene transition process which matches the location of the user to the origin and the visible plane to the plane shown to the user by changing the coordinate system, a process which clips objects not included in the 3D space in the vision, a process which projects the object in two dimensions, and a rasterization process which converts the object to pixels.

The display module 240 functions to display the 3D graphic images generating according to the operation of the portable terminal. In particular, under the control of the steady rendering module 220, the display module 240 replays the 3D image generated and rendered by the 3D rendering pipe line 230.

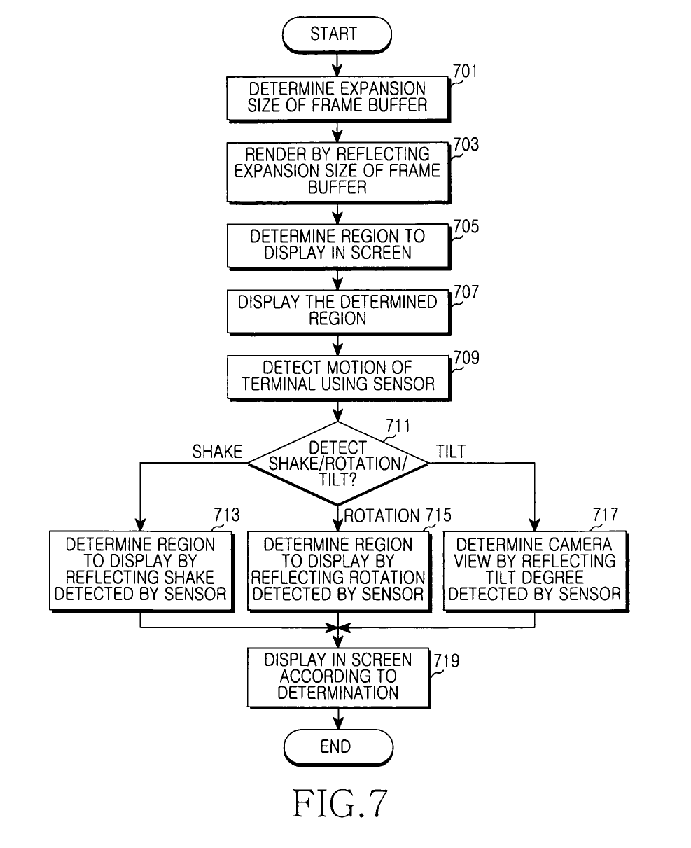

FIG. 7 illustrates a display process based on the rendering and the motion of the portable terminal according to an embodiment of the present invention.

In block 701, the terminal determines the expanded size of the frame buffer. The terminal may expand the frame buffer up to the size of the square which circumscribes the circle in which the distance r from the center O of the screen to the vertex as its radius as shown in FIG. 3C, such that the size of the expanded frame buffer may cover both of the landscape mode screen and the portrait mode screen of the terminal as shown in FIGS. 3A and 3B.

In block 703, the terminal renders the 3D graphic image corresponding to the expanded size of the frame buffer. That is, the terminal pre-renders the 3D graphic image of the size corresponding to the screen region and the surrounding regions.

The terminal determines the region to display in its screen from the pre-rendered regions in block 705, and displays the 3D graphic image rendered in the determined region onto the screen in block 707.

Next, the terminal detects its motion using the sensor in block 709, and examines whether the shake, the rotation, or the tilt of the terminal is detected based on the result of the motion detection in block 711.

Upon detecting the shake of the terminal, the terminal obtains the information indicating the shake level of the terminal using the sensor and determines the region to display in the pre-rendered regions based on the shake level in block 713. More specifically, the terminal obtains the direction and acceleration information of the terminal using the sensor, determines the motion vector V indicating the shake of the terminal as shown in FIG. 5A, and determines to change the display region from abcd to a′b′c′d′ by modifying the center of the screen by the inverse vector −V of the motion vector as shown in FIG. 5B. Herein, when the center of the rendering region and the center of the screen differ from each other because of the shake, the terminal may newly render the region corresponding to the size of the expanded buffer based on the center of the changed screen.

By contrast, upon detecting the rotation of the terminal, the terminal obtains the information indicating the rotation of the terminal using the sensor and determines the region to display in the pre-rendered regions according to the rotation in block 715. For example, provided that the terminal in the landscape mode is rotated by 90 degrees as shown in FIG. 4A, the terminal vertically changes the display region in the pre-rendered regions as shown in FIG. 4B.

Upon detecting the tilt of the terminal, the terminal obtains the information indicating the tilt of the terminal using the sensor and determines the viewpoint of the camera view indicating the display viewpoint of the 3D graphic image according to the tilt in block 717. That is, the terminal determines the viewpoint of the camera view to modify the angle of the 3D graphic image to display in the screen. For example, when the terminal is tilted by θ, the viewpoint of the camera facing the 3D graphic image is processed to tilt by θ as illustrated in FIGS. 6A to 6C.

Next, the terminal displays the 3D graphic image in the screen according to the determination in block 719 and then finishes this process.

While the 3D graphic image is rendered and displayed, the method for pre-generating the image for the surroundings of the screen and displaying the pre-generated image according to the motion of the terminal may be applied to the 2D image display.

The portable terminal pre-renders the region displayed in the screen and the surrounding region, detects the motion of the portable terminal using the sensor, and changes the region displayed in the screen according to the detected motion. Thus, the user may comfortably watch the 3D image without shaking even in motion. Even when the portable terminal is rotated, the image is not resized at all and thus the processing may be reduced compared to the conventional portable terminal.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A rendering method using a sensor in a portable terminal, comprising:
pre-rendering a region of a size corresponding to a screen of the terminal and a surrounding region;
displaying a preset region of the pre-rendered region;
detecting motion of the terminal using the sensor; and
changing a region to display in the pre-rendered regions according to the motion.

2. The rendering method of claim 1, wherein pre-rendering the region of the size corresponding to the screen of the terminal and the surrounding region comprises:
determining a square region which circumscribes a circle that has a distance from a center of the screen to a vertex as a radius, as a rendering region; and
rendering the determined square region.

3. The rendering method of claim 2, wherein the rendering region is updated when a zoom function is utilized.

4. The rendering method of claim 1, wherein detecting the motion of the terminal using the sensor comprises:
detecting at least one of rotation, shake, and tilt of the terminal using the sensor which detects at least one of a direction, acceleration, and a slope of the terminal.

5. The rendering method of claim 4, wherein changing the region to display comprises:
determining a rotation degree of the terminal using the slope detected by the sensor; and
changing a corresponding rendering region to the region to display by rotating the preset region of the pre-rendered regions by the rotation degree.

6. The rendering method of claim 4, wherein changing the region to display comprises:
determining a motion vector according to the shake of the terminal using the direction and the acceleration detected by the sensor; and
changing a corresponding rendering region to the region to display by readjusting a center of the preset region by an inverse vector of the motion vector.

7. The rendering method of claim 4, wherein changing the region to display comprises:
determining the tilt of the terminal using the slope detected by the sensor; and
adjusting a viewpoint of a camera view indicating a viewpoint to display according to the tilt.

8. A rendering apparatus using a sensor in a portable terminal, comprising:
the sensor configured to detect motion of the terminal;
a rendering module configured to pre-render a region of a size corresponding to a screen of the terminal and a surrounding region and change a region to display in the pre-rendered regions according to the motion; and
a display module configured to display a preset region determined by the rendering module among the pre-rendered regions.

9. The rendering apparatus of claim 8, wherein the rendering module is further configured to determine a square region which circumscribes a circle that has a distance from a center of the screen to a vertex as a radius, as a rendering region, and render the determined region.

10. The rendering apparatus of claim 9, wherein the rendering module is further configured to update the rendering region when a zoom function is utilized.

11. The rendering apparatus of claim 8, wherein the sensor is further configured to detect at least one of rotation, shake, and tilt of the terminal using the sensor which detects at least one of a direction, acceleration, and a slope of the terminal.

12. The rendering apparatus of claim 11, wherein the rendering module is further configured to determine a rotation degree of the terminal using the slope detected by the sensor, and change a corresponding rendering region to the region to display by rotating the preset region of the pre-rendered regions by the rotation degree.

13. The rendering apparatus of claim 11, wherein the rendering module is further configured to determine a motion vector according to the shake of the terminal using the direction and the acceleration detected by the sensor, and change a corresponding rendering region to the region to display by readjusting a center of the preset region by an inverse vector of the motion vector.

14. The rendering apparatus of claim 11, wherein the rendering module is further configured to determine the tilt of the terminal using the slope detected by the sensor, and adjust a viewpoint of a camera view indicating a viewpoint to display according to the tilt.

15. A portable terminal, comprising:
a sensor module configured to detect a motion of the terminal;
a buffer expansion module configured to determine a region for rendering graphic data by expanding a size of a frame buffer;
a steady rendering module configured to pre-render a region of a size corresponding to a screen of the terminal and a surrounding region and change a region to display in the pre-rendered regions according to the motion; and
a display module configured to display a preset region determined by the rendering module among the pre-rendered regions.

16. The portable terminal of claim 15, wherein the buffer expansion module is further configured to determine a square region which circumscribes a circle that has a distance from a center of the screen to a vertex as a radius, as a rendering region, and render the determined region.

17. The portable terminal of claim 16, wherein the buffer expansion module is further configured to update the rendering region when a zoom function is utilized.

18. The portable terminal of claim 15, wherein the sensor is further configured to detect at least one of rotation, shake, and tilt of the terminal using the sensor which detects at least one of a direction, acceleration, and a slope of the terminal.

19. The portable terminal of claim 18, wherein the rendering module comprises:
a rotate management module configured to determine a rotation degree of the terminal using the slope detected by the sensor, and change a corresponding rendering region to the region to display by rotating the preset region of the pre-rendered regions by the rotation degree;
a shake reduction module configured to determine a motion vector according to the shake of the terminal using the direction and the acceleration detected by the sensor, and change a corresponding rendering region to the region to display by readjusting a center of the preset region by an inverse vector of the motion vector; and
a cam view adjustment module configured to determine the tilt of the terminal using the slope detected by the sensor, and adjust a viewpoint of a camera view indicating a viewpoint to display according to the tilt.

20. The portable terminal of claim 15, further comprising a three dimensional (3D) rendering pipe line configured to process the function for rendering 3D images based on information from the steady rendering module, wherein the buffer expansion module is further configured to determine a region for rendering three-dimensional (3D) graphic data by expanding the size of the frame buffer.
